(19) United States
(12) Patent Application Publication
(10) Pub. No.: US 2002/0179799 A1
(43) Pub. Date: Dec. 5, 2002

(54) Seat track assembly

(76) Inventors: Nils O. Olsson, Glenn Ellyn, IL (US); Brian John Moore, Bracebridge (CA); Karen Eardley, Bracebridge (CA); Sean Michael Phillips, Hunstville (CA); Brent Albin Hauck, Hunstville (CA); Michael George Pattison, Bracebridge (CA)

Correspondence Address: BANNER & WITCOFF LTD.,, ATTORNEYS FOR DURA AUTOMOTIVE, 28 STATE STREET - 28TH FLOOR, BOSTON, MA, 02109, US

(21) Appl. No.: 09/874,478

(22) Filed: Jun. 4, 2001

Related U.S. Application Data
(60) Provisional application No. 60/295,230, filed on Jun. 1, 2001.

(51) Int. Cl. F16M 13/00

(52) U.S. Cl. 248/429; 248/424

(57) ABSTRACT

A seat track assembly, which includes a first track assembly having a bearing body mounted on an upper track that maintains adequate compression on a spindle with a drive gear, is disclosed. Such an assembly provides a cost effective and efficient system to reduce the amount of axial chuck, the amount of undesired fore and aft movement, in the power seat of a vehicle that exists in currently used apparatuses. The present disclosure is suitable for use in a driver's seat as well as all passenger seats in a wide variety of types of vehicles. The utilization of the present disclosure in new vehicles will provide a more comfortable ride for all passengers as well as increase their safety while traveling.

This application claims the benefit of U.S. Provisional Application No. ______, entitled SEAT TRACK ASSEMBLY, which was filed on Jun. 1, 2001 on behalf of Olsson et al.

### TECHNICAL FIELD

This disclosure relates generally to the field of seat mounting assemblies, and in particular, to vehicular seat track assemblies that reduce or eliminate unwanted fore and aft movement of a vehicular seat.

### BACKGROUND

Vehicle seats are often provided with a seat track assembly for adjusting the horizontal fore and aft seat position. Such seat track assemblies generally include upper tracks on each side of the seat movably mounted to corresponding lower tracks fixed to the vehicle. In addition, typical seat track assemblies include a sliding mechanism to control sliding movement of the upper track with respect to the lower track. The sliding mechanism may employ a roller, bearing, sliding sleeve, or other sliding components. Generally known power seat track assemblies additionally include a drive gear operatively engaging a fore and aft mounted spindle. Actuation of the drive gear, e.g., by an electric motor, rotates the spindle about its longitudinal axis to adjust the seat position. Such assemblies typically maintain the fore and aft position of the seat by means including axially fixing the drive gear in a gearbox of the seat assembly.

Such known power sliding mechanisms do not adequately eliminate fore and aft “chuck,” i.e., axial play or looseness due to, e.g., stack up of manufacturing tolerances of the various components. Past attempts to eliminate seat chuck have included using a spring force on the drive gear, applying force either directly or indirectly against the end of the spindle by means of a set screw through a wall of the gearbox, etc.

Thus, a need exists for seat track assemblies that better control chuck or undesired vehicular seat forward and aft movement, preferably, at a reduced cost.

It is therefore a primary object of vehicular seat track assemblies in accordance with the present disclosure to provide a seat track assembly that reduces or eliminates undesirable fore and aft “chuck” movement of a vehicular seat. Additional objects and features of such vehicular seat track assemblies and/or preferred embodiments thereof will be better understood from the following disclosure and detailed description.

### SUMMARY

In accordance with one aspect, a vehicular seat track assembly comprises a seat track and an elongated threaded spindle mounted in fixed axial position relative the seat track, e.g., an upper track mounted in fore and aft sliding relationship with a corresponding lower seat track. In accordance with preferred embodiments, a drive gear operatively engages a spindle, such that rotation of the drive gear, e.g., by actuation of an electric motor, functions to rotate the spindle about its longitudinal axis, preferably through a nut fixed to a lower seat track, to achieve fore and aft adjustment of seat position. An axial compressive preload is applied to the spindle. Specifically, axial force is applied to the spindle at its axial centerline. In accordance with certain preferred embodiments, the axial force is applied (at either or both ends) along the axial centerline of the spindle and against an area at the radial center of the spindle, which area is less than the full cross-sectional area of the spindle. The axial compressive force can be applied in numerous alternative ways, as further discussed below. In particular, for example, a biasing member, such as a spring, resilient pad, or like device, can act, directly or indirectly, against one end of the spindle, preferably the drive gear end of the spindle (referred to below as the proximal end of the spindle), the other end (referred to below as the distal end) of the spindle being axially secured against a suitable axial bearing surface. In certain preferred embodiments, the biasing member comprises a spring metal, coil spring, etc. having an at rest position and can be displaced from its at rest position by contact with the spindle. As used here, a suitable axial bearing surface in such embodiments is a surface contacting the axial end surface of the spindle and providing axial force opposite to that applied by the aforesaid biasing member. Exemplary suitable axial bearing surfaces include the surface of a body axially fixed relative to the seat track, a flange of the seat track, etc. In accordance with alternative preferred embodiments, the axial compressive force is applied by a first biasing member acting, directly or indirectly, at the proximal end of the spindle, and a second biasing member at the distal end.

In accordance with another aspect, a vehicular seat track assembly comprises a seat track and an elongated threaded spindle mounted in fixed axial position relative the seat track, e.g., an upper track mounted in fore and aft sliding relationship with a corresponding lower seat track. The distal end of the spindle bears against a bearing surface. The bearing surface in accordance with certain preferred embodiments is the surface of a biasing member, such as, e.g., a resilient pad or like active member or device acting, directly or indirectly, against the end of the spindle. In accordance with alternative preferred embodiments, the bearing surface is the surface of a body axially fixed relative to the seat track, a flange of the seat track, etc.

In accordance with another aspect, a vehicular seat track assembly comprises a seat track and an elongated threaded spindle mounted in fixed axial position relative the seat track, e.g., an upper track mounted in fore and aft sliding relationship with a corresponding lower seat track. Axial force is applied against one or both ends of the spindle at its axial centerline by a resilient, axially compressive bearing pad. In accordance with certain preferred embodiments, the resilient, axially compressive bearing pad comprises rubber, plastic, elastomer, or other polymeric material, e.g, acetal. The seat track assembly is configured such that, in assembly, the resilient, axially compressive bearing pad is somewhat axially compressed by contact, direct or indirect, with the axial end surface of the spindle.

In accordance with another aspect, a seat track assembly comprises a first track assembly and a second track assembly. The first track assembly, generally mounted to a vehicle seat, comprises a first track mounted fore and aft in a vehicle, a bearing surface, a fore and aft spindle, and a drive gear. The drive gear is carried preferably on the proximal end portion of the spindle and is rotationally fixed relative to the spindle. The spindle is rotatably mounted axially (i.e. in a fore and aft direction) and is axially fixed relative to the upper track. In alternative embodiments, the drive gear is not axially fixed to the spindle. The spindle is optionally secured against a bearing surface at the distal end of the spindle. In accordance with certain preferred embodiments, the proximal end of the spindle is secured by the drive gear. In a preferred embodiment, the drive gear is axially spaced from the bearing surface.

In other preferred embodiments, the second track assembly, generally mounted to the vehicle floor, comprises a second track and a threaded region. In a preferred embodiment, the threaded region comprises a nut retainer fixed to the second track that holds a nut adapted to threadedly engage the spindle.

In accordance with another aspect, the spindle is held in axial compression between the drive gear and a bearing surface at the distal end of the spindle.

Additional features and advantages of this seat track assembly are apparent from, or will be set forth in, the detailed descriptions below.

### BRIEF DESCRIPTION OF THE DRAWINGS

The features of various preferred embodiments are discussed below with reference to the accompanying drawings in which:

FIG. 1 is an isometric sectional view of one embodiment of a power seat track assembly in accordance with a preferred embodiment.

FIG. 2 is a side sectional view of the disclosed seat track assembly in accordance with the embodiment of FIG. 1.

FIG. 3 is an expanded side view of the structural block assembly in accordance with the embodiment of FIG. 1.

FIG. 4 is an expanded side view of the gear assembly in accordance with the embodiment of FIG. 1.

FIG. 5 is a perspective view of a seat adjuster in accordance with the embodiment of FIG. 1.

### DETAILED DESCRIPTION OF CERTAIN PREFERRED EMBODIMENTS

Although specific embodiments of the present disclosure will now be described with reference to the drawings, it should be understood that such embodiments are by way of example only and merely illustrative of but a small number of the many possible specific embodiments which can represent applications of the principles of the present disclosure. Various changes and modifications will be obvious to one skilled in the art in view of the present disclosure and are deemed to be within the spirit and scope of the present disclosure as further defined in the appended claims. Unless defined otherwise, all technical and scientific terms used herein have the same meaning as commonly understood by one having ordinary skill in the art to which this disclosure belongs. Although other materials and methods similar or equivalent to those described here can be used in the practice or testing of the present disclosure, certain preferred methods and materials are now described.

The terms “a,” “an,” and “the” as used herein are defined to mean “one or more” and include the plural unless a contrary meaning is made clear from the particular context.

It will be apparent to one skilled in the art that the following disclosed seat track assembly typically would be employed together with a second seat track assembly laterally spaced from a first seat track assembly, i.e., a left side seat track assembly and a right side seat track assembly. In certain preferred embodiments, the two seat track assemblies are mirror images of one another.

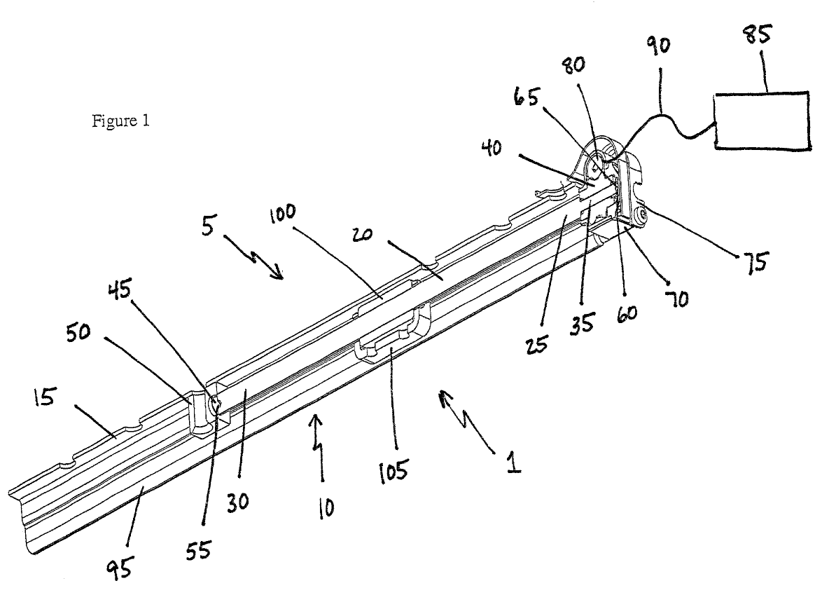

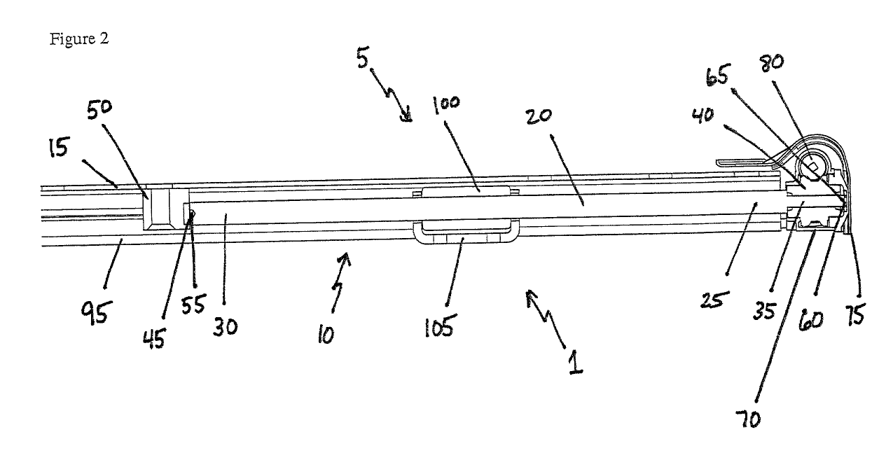

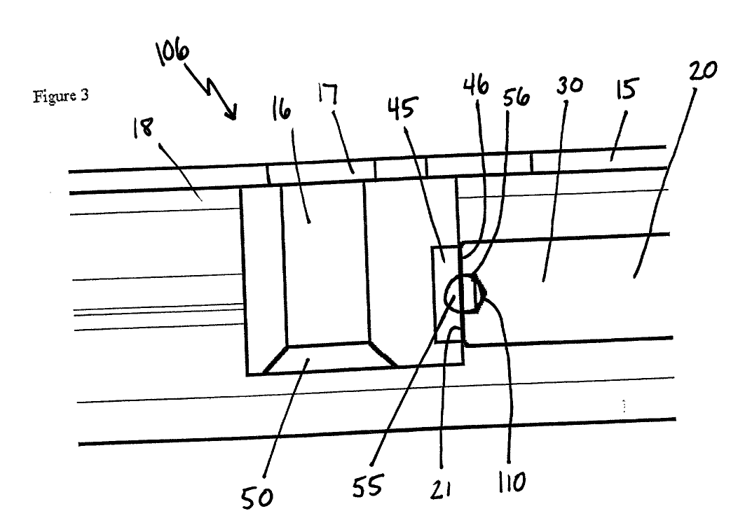

With reference to FIGS. 1-5 of the drawings, reference numeral 1 refers generally to a seat track assembly in accordance with a preferred embodiment. The seat track assembly comprises a first track assembly 5 and a second track assembly 10, which act in cooperation to adjust the fore and aft movement of a vehicular seat. The first track assembly 5 comprises at least one first track assembly track 15, which can be seen to be an upper track in the illustrated embodiment and will herein be referred to as the upper track 15. In one aspect, the upper track 15 is generally adapted to be secured to a vehicular seat.

The first track assembly further comprises a spindle 20. The spindle 20 is elongated and is preferably threaded in at least one portion. The spindle 20 need not be threaded its entire length. In one embodiment, the spindle 20 is threaded where it is in contact with the second track assembly 10. The spindle comprises a proximal end 25 and a distal end 30. In a preferred embodiment, the proximal end comprises a reduced diameter shaft portion 35, which is adapted to operatively engage a drive gear 40. While the shaft portion 35 is defined herein to be the portion of the spindle 20 that is operatively engaged by the drive gear 40, other embodiments are contemplated by the inventors and are within the scope and spirit of the present disclosure. An example of such another embodiment is that shaft portion 35 can be a separate component of the spindle 20. In alternative embodiments, the drive gear can be formed as a unitary part of the spindle.

In another embodiment, the shaft portion 35 threadedly engages drive gear 40. In certain embodiments, the shaft portion 35 is not threaded along its entire length. In certain preferred embodiments, the shaft portion 35 is not axially fixed to the drive gear 40. Optionally, shaft portion 35 is splined or otherwise configured to be rotationally fixed to drive gear 40, with or without being axially fixed thereto.

In certain preferred embodiments, the drive gear 40 is axially fixed relative to the upper track 15. In certain preferred embodiments, the drive gear 40 is axially spaced from the bearing pad surface 46. In certain preferred embodiments, the drive gear 40 contributes to securing the spindle 20 at its distal end 30.

Referring again to FIG. 1, the illustrated embodiment is seen to comprise a bearing body 50 axially fixed relative to the upper track 15 at the distal end 30 of spindle 20. In the preferred embodiment illustrated in the drawings, the bearing body 50 is adapted to be secured to upper track 15 by a suitable fastener via fastener hole 16 in bearing body 50 and hole 17 in flange 18 of upper track 15. In certain preferred embodiments, the bearing body 50 is a cube measuring about 10-20 millimeters on each side. The bearing body 50 can be formed of any suitable material including, e.g. resilient materials such as elastomer, rubber, plastic, or other polymeric material, or non-resilient material such as steel, or any other material suitable to provide a bearing surface 56 or to support a bearing pad 45 for the distal end 30 of spindle 20 as further discussed below. More specifically, in embodiments employing an elastomeric or other axially compressible bearing body 50, the spindle 20 optionally can bear directly against the bearing body 50. In embodiments employing steel or other non-axially compressible bearing body, if a biasing member is employed at the proximal end of the spindle (i.e., the gearbox end), axial chuck movement can be prevented by such proximal end biasing member and the spindle can bear directly against such non-axially compressible bearing body. In other embodiments employing steel or other non-axially compressible bearing body, a resilient, axially compressible bearing pad can be mounted to or otherwise carried by the bearing body to provide axial compressive force. A bearing pad or a biasing member can be used at the distal end together with a biasing member or bearing pad at the proximal end. In the embodiment illustrated in the drawings, a bearing pad 45 comprises a resilient polymeric material as further discussed below, carried by bearing body 50. It will be understood from this disclosure that in certain alternative embodiments, the bearing body 50 is not a separate component from the bearing pad 45. In such preferred embodiments, the bearing body 50 is made of a resilient axially compressible material similar to the bearing pad 45.

The first bearing pad 45 is seen to have a first bearing pad surface 46, which is not axially fixed. It should be understood that the first bearing pad surface 46 is subject to axial movement upon being compressed by a first end surface 21 of the spindle 20, and that the amount of axial movement may not be constant throughout the first bearing pad surface 46. For example, in a preferred embodiment, the portion of the first bearing pad surface 46 in contact with the first end surface 21 may be compressed to effect a greater amount of axial movement than the portion of the first bearing pad surface 46 that is not in direct contact with the first end surface 21. Accordingly, the first bearing pad surface 46 would, in such an instance, not be axially compressed equally throughout the entire bearing pad surface 46. Thus, it is preferred that the first bearing pad 45 be made of a resilient material. Suitable materials include, e.g., rubber, plastic, elastomer, and other such materials, such as PTFE, or any other materials that can withstand the axially compressive forces within the assembly.

In one aspect of the present disclosure, to help reduce the amount of chuck present in a vehicular power seat, a first bearing pad 45 is placed between the bearing body 50 and the spindle 20. In a preferred embodiment, the first bearing pad 45 is placed between the bearing body 50 and the distal end 30. The first bearing pad surface 46 should preferably be adapted to receive a first ball bearing 55, so that the first ball bearing 55 is held in place between the bearing body 50 and the spindle 20, and more directly between the first bearing pad surface 46 and the distal end 30. In certain preferred embodiments, the first ball bearing 55 has a first ball bearing surface 56 that is adapted to be contacted by the spindle 20, and more preferably by the first bearing pad surface 46 and the distal end 30. In such preferred embodiments, the distal end 30 of the spindle 20 is adapted to receive the first ball bearing 55 such as in a socket 110 formed via machining or other similar process. In such preferred embodiments, the first bearing socket or other adaptation 110 is spherically contoured. The insertion of a first ball bearing 55 in the assembly serves to reduce the amount of friction between the spindle 20 and the bearing body 50, and even more preferably between the distal end 30 and the first bearing pad surface 46, thereby making the seat assembly more efficient. The first ball bearing 55 also serves to reduce the chance of the spindle 20 from becoming dislodged from the bearing body 50 and even more preferably from the bearing pad surface 46.

In the illustrated embodiment, a second bearing pad 60 is positioned between the shaft portion 35 of the spindle 20 and the mounting bracket 75. Optionally, mounting bracket 75 is a biasing member asserting an axially compressive force against spindle 20 via bearing pad 60 and ball bearing 65. Alternatively, bearing pad 60 is deleted, especially if sufficient biasing force is achieved by means of such biasing member. Optionally, mounting bracket 75 is a unitary or integral component of gearbox 70. In a preferred embodiment, the second bearing pad 60 is made of a material, which is the same as or similar to the aforementioned resilient materials of the first bearing pad 45. The second bearing pad 60 is seen to fit a second ball bearing 65, so that the second ball bearing 65 is held in place between the second bearing pad 60 and the spindle 20. It can be seen in the illustrated embodiment that a ball bearing receiving well also is formed in the axial end of shaft portion 35.

In certain preferred embodiments, the drive gear 40 and other related components are at least partially covered by a gearbox 70. In certain preferred embodiments, the gearbox 70 positions the components and protects the components from damage. In certain preferred embodiments, the mounting bracket 75 mounts the gearbox 70 to the upper track 15.

The gearbox 70 houses a standard worm gear 80, which operatively engages the drive gear 40, and is driven by a standard bi-directional motor 85 via a cable 90. In a preferred embodiment, the cable is a Bowden cable.

The second track assembly 10 comprises at least one second track assembly track 95, which can be seen in FIG. 1 to be a lower track in the illustrated embodiment and will herein be referred to as the lower track 95. In certain preferred embodiments, the lower track 95 is generally adapted to be secured to a vehicular floor. The second track assembly 10 further comprises a threaded region 100 that is adapted to fit the spindle 20. In certain preferred embodiments, the threaded region 100 is a nut that is secured to the lower track 95 by a nut retainer 105. In other preferred embodiments, a unibody threaded region 100 molded to or as a unitary part of the lower track 95 may be employed.

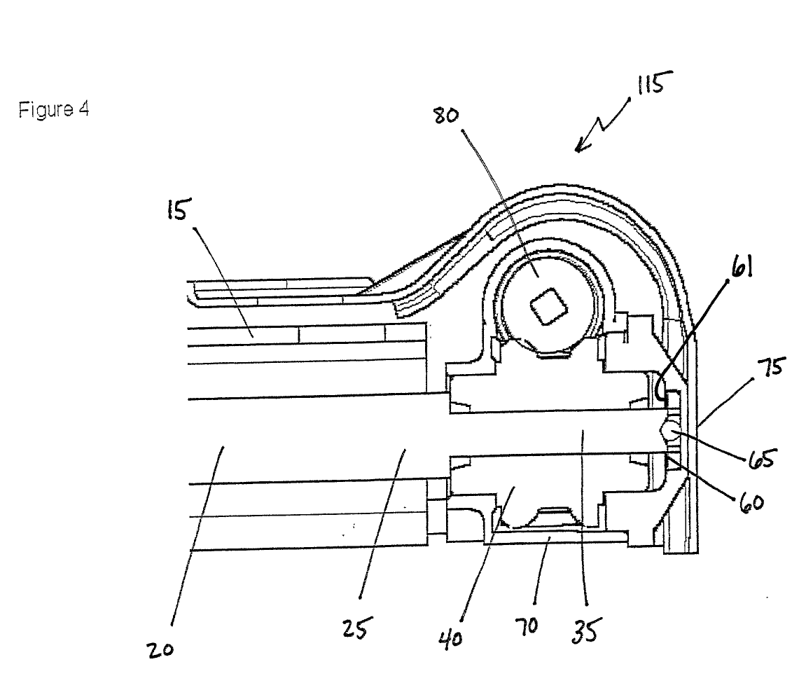

With reference to FIG. 4 of the drawings, the gear assembly 115 is contained within a gearbox 70. The gear assembly 115 comprises a standard worm gear 80 that acts upon a drive gear 40. The drive gear 40, in turn, is in operative engagement with the proximal end 25. In a preferred embodiment, the drive gear 40 is in operative engagement with a threaded shaft portion 35. In another preferred embodiment, the shaft portion 35 is engaged with the drive gear 40. An important feature of the present disclosure is that the drive gear 40 need not be rigidly fastened to the spindle 20 or shaft portion 35 to reduce the amount of fore and aft chuck of the spindle 20.

In a preferred embodiment, a second ball bearing 65 is held between a second bearing pad 60 and the spindle 20. In another preferred embodiment, a second ball bearing 65 is held between a second bearing pad surface 61 and the shaft portion 35. In other preferred embodiments, the proximal end of the spindle 20 or shaft portion 35 is adapted to receive a second ball bearing 65. As mentioned previously, the second bearing pad 60 and the second ball bearing 65 are utilized to reduce the friction between the drive gear 40 and the spindle 20 or shaft portion 35. The reduction of friction lends a more efficient system.

In yet another preferred embodiment, a mounting bracket 75 mounts the gearbox 70 to the upper track 15.

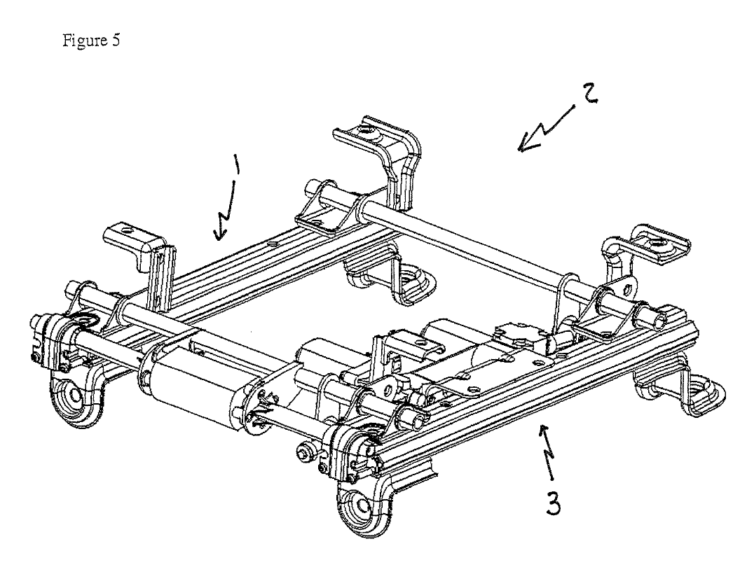

With reference to FIG. 5, a seat assembly 2 is seen to comprise above described seat track assembly 1 in assembly with a second seat track assembly. More specifically, seat assembly 2 comprises left seat track assembly 3 and right seat track assembly 1. The left seat track assembly 3 is substantially identical to the right seat track assembly 1, although it is within the scope of the present disclosure that the left seat track assembly 3 be non-identical to the right seat track assembly 1. Also, the upper track with spindle 20 optionally can be reversed with the lower track.

Numerous characteristics and advantages of this disclosure have been set forth in the foregoing description, together with details of the structure and function of its embodiments, and the novel features thereof are pointed out in the appended claims. The disclosure, however, is illustrative only. For instance, mounting the upper track assembly to the floor of a vehicle instead of to the seat of a vehicle and mounting the lower track assembly to the seat of a vehicle instead of to the floor of a vehicle is within the scope and spirit of the present disclosure. Further, alternative embodiments of the present disclosure including left- and right-handed seat tracks are also within the scope and spirit of the present disclosure and should be considered as such. Other changes may be made in detail, especially in matters of function, intended uses, shape, size and arrangement of parts, within the principles of the disclosure, to the full extent indicated by the broad general meaning of the terms in which the appended claims are expressed.

What is claimed is:

1. A vehicular seat track assembly comprising a seat track, an elongated spindle mounted in fixed axial position relative the seat track, and a drive gear mounted at a proximal end of the spindle, wherein axial compressive preload is applied against the proximal end and a distal end of the spindle at its axial centerline.

2. The vehicular seat track assembly of claim 1 wherein axial force is applied at one end along the axial centerline of the spindle and against an area at the radial center of the spindle, which area is less than the full cross-sectional area of the spindle.

3. The vehicular seat track assembly of claim 1 wherein axial force is applied at each end along the axial centerline of the spindle and against an area at the radial center of the spindle, which area is less than the full cross-sectional area of the spindle.

4. The vehicular seat track assembly of claim 1 wherein a biasing member applies axial compressive force, directly or indirectly, against one end of the spindle.

5. The vehicular seat track assembly of claim 4 wherein the biasing member applies axial compressive force, directly or indirectly, at the distal end of the spindle.

6. The vehicular seat track assembly of claim 4 wherein the biasing member applies compressive force against the proximal end of the spindle, the distal end of the spindle being axially secured against an axial bearing surface.

7. The vehicular seat track assembly of claim 6 wherein the axial bearing surface provides axial force opposite to that applied by the biasing member.

8. The vehicular seat track assembly of claim 6 wherein the axial bearing surface comprises a surface of a body axially fixed relative to the seat track.

9. A vehicular seat track assembly comprising a seat track and an elongated threaded spindle mounted in fixed axial position relative the seat track, wherein a first biasing member applies axial compressive force, directly or indirectly, at one end of the spindle.

10. The vehicular seat track assembly of claim 9 wherein the biasing member comprises a resilient pad.

11. The vehicular seat track assembly of claim 9 wherein the biasing member comprises a spring metal having an at rest position and being displaced from its at rest position by contact with the spindle.

12. The vehicular seat track assembly of claim 9 wherein the biasing member comprises a coil spring having an at rest position and being displaced from its at rest position by contact with the spindle.

13. A seat track assembly comprising an upper track assembly having an upper track, a bearing body axially fixed relative to the upper track, a rotatably mounted elongated threaded spindle having a proximal end and a distal end bearing axially against the bearing body, and a drive gear in operative engagement with the proximal end of the spindle.

14. The seat track assembly of claim 13 further comprising a lower track assembly axially engaging in an operatively sliding relationship with the upper track assembly, the lower track assembly comprising a lower track and a threaded region fixed to the lower track.

15. The seat track assembly of claim 13 wherein the drive gear is axially spaced from the bearing body.

16. The seat track assembly of claim 13 wherein the spindle has a shaft portion that is operatively engaged by the drive gear.

17. The seat track assembly of claim 13 wherein the bearing body comprises an axially compressing resilient bearing pad.

18. The seat track assembly of claim 13 wherein the drive gear is axially fixed relative to the upper track assembly.
